(19) United States
(12) Patent Application Publication
(10) Pub. No.: US 2013/0187463 A1
(43) Pub. Date: Jul. 25, 2013

(54) Switching Power Control Device and Control Method of the Same

(71) Applicant: ASUSTek COMPUTER INC., Taipei (TW)

(72) Inventor: Yi-Peng Lin, Taipei (TW)

(73) Assignee: ASUSTeK COMPUTER INC., Taipei (TW)

(21) Appl. No.: 13/738,718

(22) Filed: Jan. 10, 2013

(30) Foreign Application Priority Data
Jan. 19, 2012 (TW) 101102201

(51) Int. Cl. G05F 1/10

(52) U.S. Cl. CPC G05F 1/10
USPC 307/43

(57) ABSTRACT

A switch power control device adapted to a plurality of power devices includes a PWM controller, a plurality of phase-extension driving modules and a detection module. The PWM controller generates a plurality of original PWM signals to corresponding phase-extension driving modules. When the detection module detects the output voltage is outside the safe range, the detection module controls the phase-extension driving module to generate the synchronous phase-extension PWM signals to the power devices. Consequently, the disclosure can stabilize the output voltage.

### CROSS-REFERENCE TO RELATED APPLICATION

This application claims the priority benefit of Taiwan application serial No. 101102201, filed on Jan. 19, 2012. The entirety of the above-mentioned patent application is hereby incorporated by reference herein and made a part of specification.

### BACKGROUND OF THE INVENTION

1. Field of the Invention

The disclosure relates to a method for controlling power supply stable technology and, more particularly, to a switch power supply control device and a stable controlling method.

2. Description of the Related Art

A switch power supply has excellence in larger output current and high efficiency, which is wildly used in computer systems. With the development of semiconductor element technology, the operation frequency and load transient current of components used in a computer system, such as a central processing unit (CPU), a chipset and etc., are more and more fast. The requirement on the power supply has become more and more rigorous. In addition to having high efficiency, the switch power supply further should response to quickly in great variation of load.

For example, the variation of the load is very violent when a multi-phase power device such as a display card or a motherboard operates in overclock status. The power supply drains much current, and then causes output voltage undershot, when the load of power supply change from light load to heavy load. Hence unsteady power supply may cause load damage easily.

### BRIEF SUMMARY OF THE INVENTION

A switch power control device adapted to a plurality of power devices includes a pulse width modulation (PWM) controller, a plurality of phase-extension driving modules and a detection module. The PWM controller generates a plurality of original PWM signals to corresponding phase-extension driving modules. When the detection module detects an output voltage of the power devices within a safe range, the phase-extension driving module generates a plurality of asynchronous phase-extension PWM signals to the power devices, respectively; when the detection module detects the output voltage of the power devices outside of the safe range, the detection module controls the phase-extension driving module to generate the synchronous phase-extension PWM signals to the power devices, respectively.

A power control method is applied to a switch power supply control device and a plurality of power devices. The switch power control device includes a PWM controller and a plurality of phase-extension driving modules. The PWM controller generates a plurality of original PWM signals to the corresponding phase-extension driving modules. The power control method includes detecting whether an output voltage of the power devices is within a safe range; when the output voltage is within the safe range, the phase-extension driving modules generate a plurality of asynchronous phase-extension PWM signals and outputting the phase-extension PWM signals to the corresponding power devices, respectively; and when the output voltage is out of the safe range, the phase-extension driving modules generate a plurality of synchronous phase-extension PWM signals and outputting the phase-extension PWM signals to the corresponding power devices, respectively.

### BRIEF DESCRIPTION OF THE DRAWINGS

FIG. 1 is a block diagram showing a switch power control device according to an embodiment of the disclosure;

FIG. 2 is a block diagram showing detail of a phase-extension driving module in an embodiment of the disclosure;

FIG. 3 is a diagram showing waveforms of output voltage, load, and phase-extension PWM signals in an embodiment of the disclosure;

FIG. 4 is a block diagram showing a switch power control device in another embodiment of the disclosure;

FIG. 5 is a block diagram showing detail of a phase-extension driving module in another embodiment of the disclosure;

FIG. 6 is a diagram showing waveforms of an original PWM signal generated from a PWM controller and phase-extension PWM signals output from a phase-extension driving module in an embodiment of the disclosure; and

FIG. 7 is a flowchart showing a power control method in an embodiment of the disclosure.

### DETAILED DESCRIPTION OF THE EMBODIMENTS

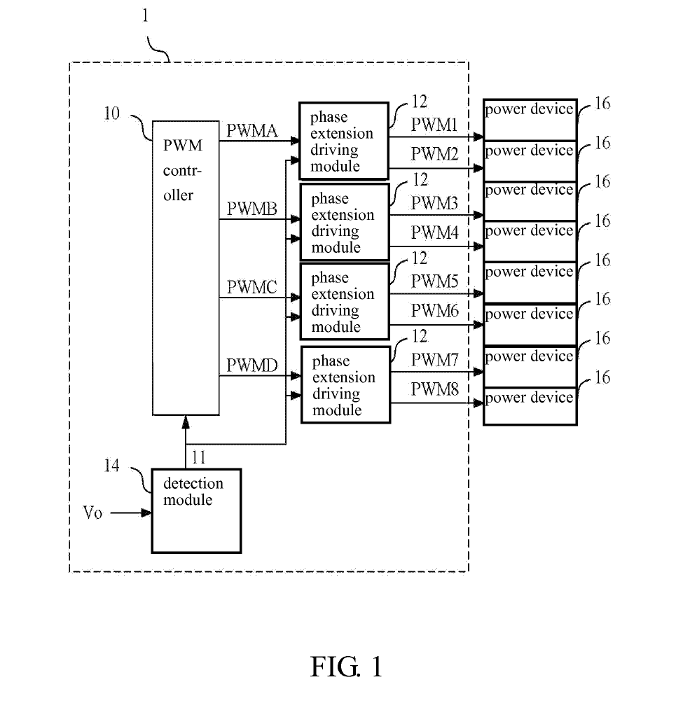

FIG. 1 is a block diagram showing a switch power supply control device according to an embodiment of the disclosure. A switch power supply control device 1 includes a PWM controller 10, a plurality of phase-extension driving modules 12 and a detection module 14.

The PWM controller 10 generates a plurality of original PWM signals. In the embodiment, the PWM controller 10 is an original four-phase control module which generates four original asynchronous phase PWM signals PWMA, PWMB, PWMC, and PWMD. The PWM controller 10 also may be eight-phase or other phases to generate PWM signals of different phase number, which is not limited herein.

The four original PWM signals PWMA, PWMB, PWMC, and PWMD are transmitted to corresponding four phase-extension driving modules 12, respectively. In an embodiment, each of the phase-extension driving modules 12 can generate two phase-extension PWM signals according to the original PWM signals PWMA, PWMB, PWMC, and PWMD, respectively. Therefore, the extension driving module 12 also can generate a plurality of phase-extension PWM signals such as four or eight, which is not limited herein. In an embodiment, the four phase-extension driving modules 12 generate eight phase-extension PWM signals PWM1 to PWM8. The phase-extension PWM signals PWM 1 to PWM 8 are further transmitted to power devices 16 to start the power devices 16 which provide power to a load at appropriate time (not shown).

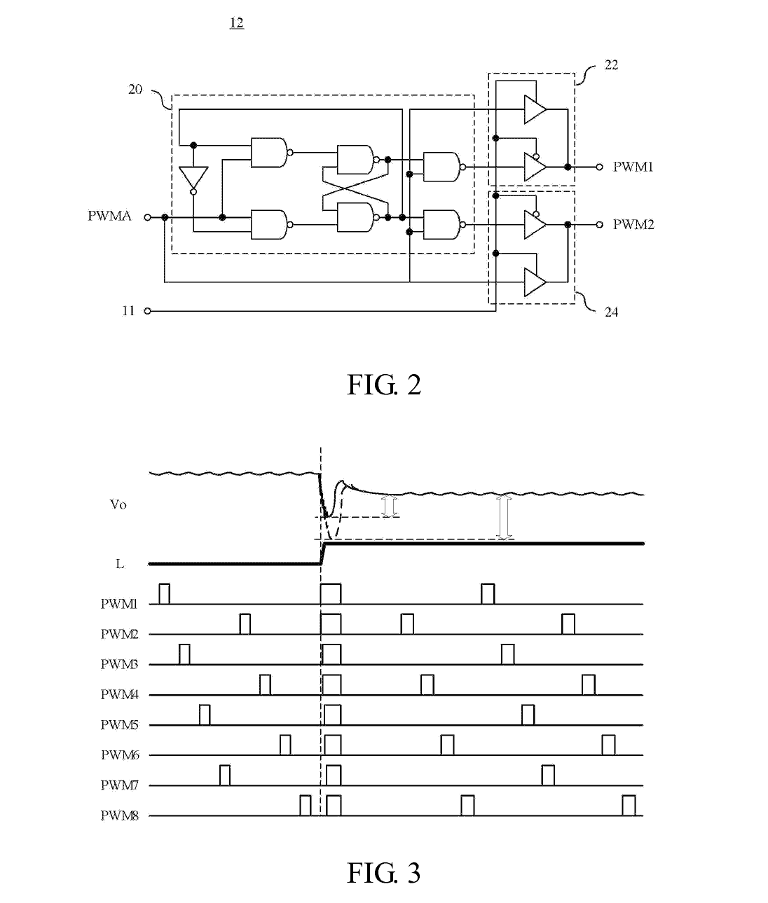

FIG. 2 is a block diagram showing detail of a phase-extension driving module in an embodiment of the disclosure. The phase-extension driving module 12 includes a phase-extension element 20, a first selector 22, and a second selector 24.

An input of the phase-extension element 20 receives one of the original PWM signals (such as PWMA herein) from the PWM controller 10. The original PWM signal PWMA is converted to two asynchronous phase-extension PWM signals PWM1 and PWM2 via the phase-extension element 20, and then via the first selector 22 and the second selector 24, respectively. The two phase-extension PWM signals PWM1 and PWM2 are outputted to the two power devices 16, respectively. To be note, the phase-extension element 20 and the selectors 22 and 24 described in this embodiment are not limited the disclosure herein. In other embodiment, the extension driving module can use any extension element and selector with the same function.

The detection module 14 in FIG. 1 can receive the output voltage Vo of the power signal output from the power devices 16 and determine whether the output voltage Vo is within the safe range. The safe range can be set according to various situations. Furthermore, the safe range may be set according to whether the output voltage is smaller than a specific value, or the voltage drop ratio of output voltage is lower than a specific value.

When the output voltage Vo is within the safe range, the detection module 14 controls the selectors 22 and 24 to generate two asynchronous phase-extension PWM signals PWM1 and PWM2 which transmit to the power devices 16. The power device 16 turns on to provide the power signal according to the PWM1 and PWM2.

However, when the load connected to the power devices 16 changes, for example, the load is changed from the light load status to the heavy load status, the current and the voltage drop sharply caused by the increase of the load in which the output voltage happens undershoot easily (as shown in dotted line in FIG. 3). At this situation, the detection module 14 detects the output voltage Vo outside the safe range.

In an embodiment, when the detection module 14 determines that the output voltage Vo is outside the safe range, the detection module 14 generates a compensation signal 11 for controlling the original PWM signals PWMA, PWMB, PWMC, and PWMD to be enabled synchronously, and then transmit the synchronous enabled signals PWMA, PWMB, PWMC, and PWMD to the phase-extension driving module 12. As shown in FIG. 2, the detection module 14 further transmits the compensation signal 11 to the selectors 22 and 24 of the phase-extension driving module 12 for controlling the selectors 22 and 24 to produce the synchronous enabled phase-extension PWM signals PWM1 and PWM2.

FIG. 3 is a diagram showing waveforms of output voltage, load, and phase-extension PWM signals PWM1 to PWM8 in an embodiment of the disclosure.

When the output voltage Vo is within the safe range, the phase-extension PWM signals PWM 1 to PWM 8 staggered arrangement in a time scale are caused by the phase-extension mechanism of the phase-extension driving module and therefore, the power devices 16 are turned on at different time. When the load increases suddenly, the output voltage Vo drops rapidly. The output voltage Vo (as shown in a dotted curve in FIG. 3) indicates the switch power supply control device without the compensation mechanism, in which the output voltage Vo has a undershoot sharply.

The output voltage Vo (as shown in a solid-line curve in FIG. 3) indicates the switch power supply control device with the compensation mechanism. When the detection module 14 detects the output voltage Vo outside the safe range, the detection module 14 generates the compensation signal 11 to the phase-extension driving modules 12 and the PWM controller 10 to produce synchronous the phase-extension PWM signals outputting from the phase-extension driving modules 12. Therefore, the extension driving modules 12 generate the synchronous phase-extension PWM signals PWM 1 to PWM 8 for compensating the output voltage Vo of all the power devices 16. Consequently, as shown in FIG. 3, the undershoot voltage of output voltage Vo with compensation is better than without compensation.

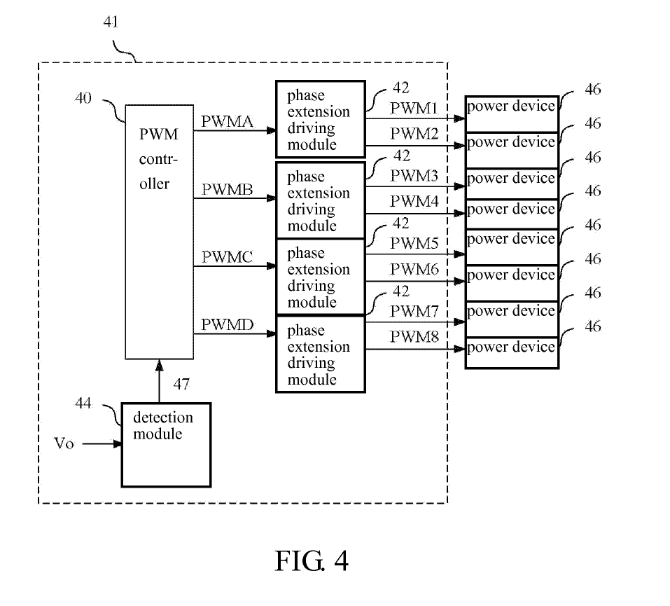

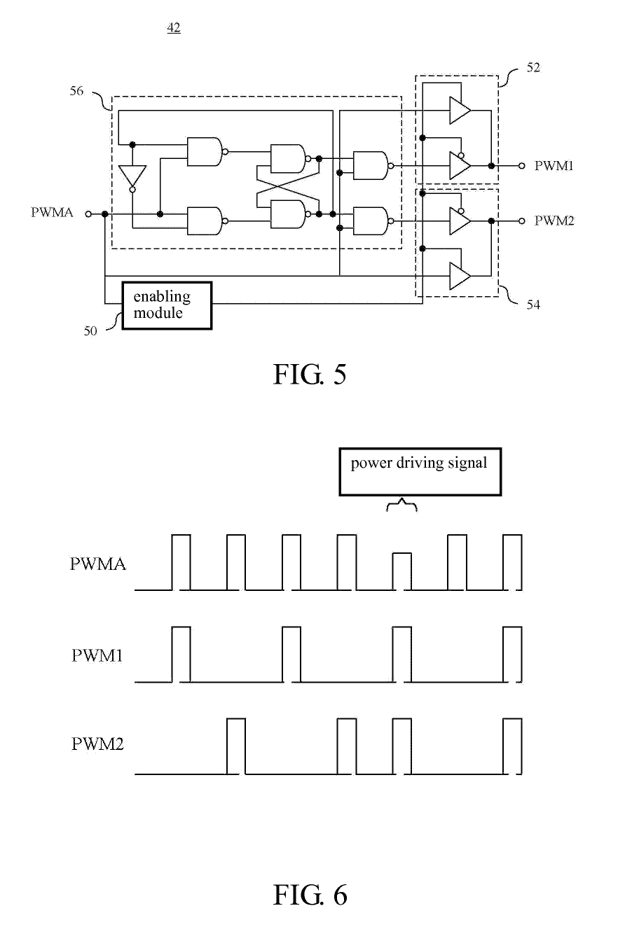

FIG. 4 is a block diagram showing a switch power supply control device in another embodiment of the disclosure. FIG. 5 is a block diagram showing detail of a phase-extension driving module in another embodiment of the disclosure. FIG. 6 is a diagram showing waveforms of an original PWM signal generated from a PWM controller and phase-extension PWM signals outputting from a phase-extension driving module in an embodiment of the disclosure.

The similar portion between the switch power supply control devices in FIG. 1 and FIG. 4 is omitted herein. In this embodiment, the difference in the FIG. 1 and FIG. 4 is the detection module 44 which is directly connected to the PWM controller 40 and unnecessarily connected to the phase-extension driving module 42. Thus, when the detection module 44 detects the output voltage Vo is out side of the safe range, the detection module 44 transmits a compensation signal 47 to the PWM controller 40. The PWM controller 40 generates a power driving signal (as shown in FIG. 6) and transmit the power driving signal to the phase-extension driving module 42. Moreover, the original power driving signal has a high voltage level and a low voltage level which is different from the PWM signals PWMA, PWMB, PWMC and PWMD.

In an embodiment, the phase-extension driving module 42 in FIG. 5 includes an enabling module 50 which detects the generation of the original power driving signal PWMA. When the PWM controller generates the original power driving signal PWMA, the enabling module 50 enables the selectors 52 and 54 for outputting the phase-extension (such as PWM1 and PWM2 in FIG. 6). The synchronous phase-extension PWM signals are used to turn on the power devices 16 and compensate the undershoot voltage in the load change from light load status to a heavy load status.

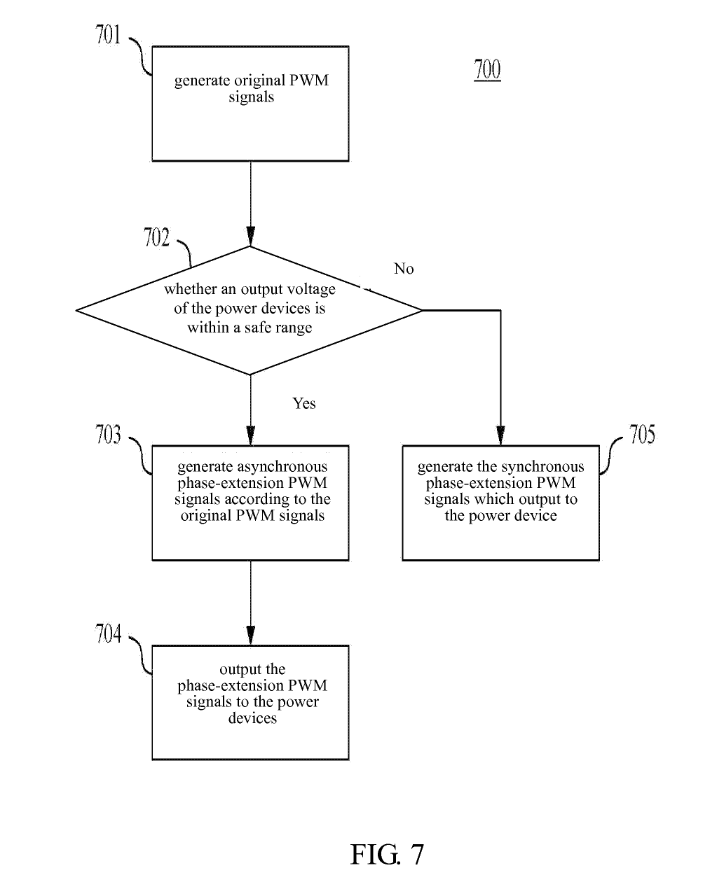

FIG. 7 is a flowchart showing a power control method in an embodiment of the disclosure. The power control method 700 can be applied to the switch power supply control device 1 in FIG. 1 and the switch power control device 41 in FIG. 4.

At step 701, the PWM controller 12 of the switch power supply control device 1 generates the original PWM signals PWMA, PWMB, PWMC, and PWMD which output to corresponding phase-extension driving modules 12.

At step 702, determining whether the output voltage Vo is within the safe range.

At step 703, when the output voltage Vo is within the safe range, a plurality of phase-extension driving modules 12 generate asynchronous phase-extension PWM signals PWM 1 to PWM 8 according to the original PWM signals PWMA, PWMB, PWMC, and PWMD, respectively.

At step 704, the phase-extension PWM signals PWM 1 to PWM 8 output to the power devices 16.

At step 705, when the output voltage is outside the safe range, for example, the output voltage is lower than the safe range, the phase-extension driving modules 12 generate the synchronous phase-extension PWM signals PWM 1 to PWM 8 which output to the power device 16.

Although the present disclosure has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A switch power supply control device adapted to a plurality of power devices, comprising:
a pulse width modulation (PWM) controller for generating a plurality of original PWM signals;
a plurality of phase-extension driving modules receiving the original PWM signals correspondingly; and
a detection module, wherein when the detection module detects an output voltage of the power devices is within a safe range, the phase-extension driving modules generate a plurality of asynchronous phase-extension PWM signals to the power devices, respectively; when the detection module detects that the output voltage is out of the safe range, the detection module controls the phase-extension driving modules to generate the synchronous enabling phase-extension PWM signals to the power devices.

2. The switch power supply control device according to claim 1, wherein when the detection module detects the output voltage outside the safe range, a light load state is converted to a heavy load state to make the output voltage lower than the safe range.

3. The switch power control device according to claim 2, wherein when the output voltage is lower than the safe range, the detection module generates a compensation signal to the phase-extension driving modules and the PWM controller, and the phase-extension driving modules generate the synchronous phase-extension PWM signals.

4. The switch power control device according to claim 2, wherein when the output voltage is lower than the safe range, the detection module generates a compensation signal to the PWM controller, and the phase-extension driving modules generate the synchronous phase-extension PWM signals.

5. The switch power control device according to claim 4, wherein after the detection module generates the compensation signal to the PWM controller, the PWM controller generates a power driving signal to the phase-extension driving modules, and the power driving signal has a high voltage level and a low voltage level differed with original PWM signals.

6. The switch power control device according to claim 1, wherein each of the phase-extension driving modules includes:
a phase-extension element receiving the original PWM signals; and
a plurality of selectors connected with the phase-extension element and outputting the phase-extension PWM signals, respectively.

7. The switch power control device according to claim 1, wherein each of the phase-extension driving modules generates two phase-extension PWM signals.

8. The switch power control device according to claim 7, wherein each of the phase-extension driving modules includes:
a phase-extension element receiving the original PWM signals;
a first selector connecting with the phase-extension element for outputting a first phase-extension PWM signal; and
a second selector connecting with the phase-extension element for outputting a second phase-extension PWM signal.

9. The switch power control device according to claim 8, wherein each of the phase-extension driving modules further includes:
an enabling module connected to the PWM controller, the first selector, and a second selector.

10. The switch power control device according to claim 1, wherein when the detection module detects the output voltage outside the safe range, the detection module controls the PWM controller generating original synchronous PWM signals.

11. A power supply control method, applied to a switch power supply control device and a plurality of power devices, wherein the switch power control device includes a PWM controller and a plurality of phase-extension driving modules, the PWM controller generates a plurality of original PWM signals to the corresponding phase-extension driving modules, and the power supply control method includes:
detecting whether an output voltage of the power devices is within a safe range; and
when the output voltage is within the safe range, the phase-extension driving modules generating a plurality of asynchronous phase-extension PWM signals and outputting the phase-extension PWM signals to the corresponding power devices, respectively, and
when the output voltage is out of the safe range, the phase-extension driving modules generate a plurality of synchronous phase-extension PWM signals and outputting the phase-extension PWM signals to the corresponding power devices, respectively.

12. The power control method according to claim 11, wherein when the output voltage is out of the safe range caused by a light load status changing to a heavy load status, the output voltage is lower than the safe range.

13. The power control method according to claim 12, wherein when the output voltage is lower than the safe range, the method further including:
generating a compensation signal to the phase-extension driving modules and the PWM controller, and the phase-extension driving module generating the synchronous phase-extension PWM signals.

14. The power control method according to claim 12, wherein when the output voltage is lower than the safe range, the method further including:
generating a compensation signal to the PWM controller, and phase-extension driving module generating the synchronous phase-extension PWM signals.

15. The power control method according to claim 14, wherein after the detection module generates the compensation signal to the PWM controller, the PWM controller generates a power driving signal to the phase-extension driving modules, and the power driving signal has a high voltage level and a low voltage level differed with original PWM signals.

16. The power control method according to claim 11, wherein each of the phase-extension driving modules generates two phase-extension PWM signals.

17. The power control method according to claim 11, wherein when detect the output voltage outside the safe range, and the PWM controller generates original synchronous PWM signals.
